(19) United States
(12) Patent Application Publication
(10) Pub. No.: US 2008/0271839 A1
(43) Pub. Date: Nov. 6, 2008

(54) METHOD AND TOOL FOR CREATING A PASSIVE SHIM LOCATION WITHIN A GRADIENT COIL

(75) Inventors: Neil Clarke, Oxford (GB); John Mark Crouchen, Devon (GB); Alan McKendry, Devon (GB)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/742,821

(22) Filed: May 1, 2007

(51) Int. Cl. B29C 47/00

(52) U.S. Cl. 156/244.22; 156/556

(57) ABSTRACT

A method for creating a passive shim location in a gradient coil assembly of a magnetic resonance imaging system includes placing at least one tool in a volume between an inner gradient coil assembly and an outer gradient coil assembly. The tool includes an inner core and an outer sleeve. The inner core is removably housed in the outer sleeve. The volume is then filled with a bonding material. Once the bonding material has cured, the inner core is removed from the outer sleeve. The outer sleeve may also be removed from the volume.

### FIELD OF THE INVENTION

The present invention relates generally to magnetic resonance imaging (MRI) systems and in particular to a method and tool for creating a passive shim location within a gradient coil of a MRI system.

### BACKGROUND OF THE INVENTION

Magnetic resonance imaging (MRI) is a medical imaging modality that can create images of the inside of a human body without using x-rays or other ionizing radiation. MRI uses a powerful magnet to create a strong, uniform, static magnetic field (i.e., the “main magnetic field”). When a human body, or part of a human body, is placed in the main magnetic field, the nuclear spins that are associated with the hydrogen nuclei in tissue water become polarized. This means that the magnetic moments that are associated with these spins become preferentially aligned along the direction of the main magnetic field, resulting in a small net tissue magnetization along that axis (the “z axis,” by convention). An MRI system also comprises components called gradient coils that produce smaller amplitude, spatially varying magnetic fields when a current is applied to them. Typically, gradient coils are designed to produce a magnetic field component that is aligned along the z axis and that varies linearly in amplitude with position along one of the x, y or z axes. The effect of a gradient coil is to create a small ramp on the magnetic field strength, and concomitantly on the resonant frequency of the nuclear spins, along a single axis. Three gradient coils with orthogonal axes are used to “spatially encode” the MR signal by creating a signature resonance frequency at each location in the body. Radio frequency (RF) coils are used to create pulses of RF energy at or near the resonance frequency of the hydrogen nuclei. The RF coils are used to add energy to the nuclear spin system in a controlled fashion. As the nuclear spins then relax back to their rest energy state, they give up energy in the form of an RF signal. The RF signal is detected by the MRI system and is transformed into an image using a computer and known reconstruction algorithms.

MRI systems require a uniform main magnetic field, B₀, in the imaging volume, however, inhomogeneities in the magnetic field may be introduced by various factors such as manufacturing tolerances, environmental effects, design restrictions, imperfections in the magnet, ferromagnetic material near the installation site, and so forth. Inhomogeneities in the magnetic field, B₀, can adversely affect data acquisition and reconstruction of an MR image. A process known as shimming may be used to compensate for or remove inhomogeneities from the B₀ field. Shim elements, for example, passive shims such as iron cores, may be precisely placed in the magnet assembly to generate magnetic fields to offset variations in the B₀ field. Typically, passive shims are placed in a room temperature region within the magnet assembly, for example, in a gradient coil assembly. One common type of gradient coil assembly uses shielded gradient coils that consist of an inner gradient coil assembly and an outer gradient coil assembly that may be coupled together using a resilient bonding material such as epoxy resin. The volume between the inner gradient coil assembly and the outer gradient coil assembly may be used as a location for passive shims.

It would be desirable to provide a method and tool for creating a passive shim location within a gradient coil. In particular, it would be desirable to provide a method and tool for creating a passive shim location in a volume between an inner gradient coil assembly and an outer gradient coil assembly.

### BRIEF DESCRIPTION OF THE INVENTION

In accordance with an embodiment, a method for creating a passive shim location in a gradient coil assembly of a magnetic resonance imaging system includes placing at least one tool in a volume between an inner gradient coil assembly and an outer gradient coil assembly, the tool comprising an inner core and an outer sleeve wherein the inner core is housed in the outer sleeve, filling the volume with a bonding material, once the bonding material has cured, removing the inner core from the outer sleeve, and removing the outer sleeve from the volume.

In accordance with another embodiment, a tool for creating a passive shim location in a gradient coil for a magnetic resonance imaging system includes an inner core, and an outer sleeve configured to removably house the inner core, the outer sleeve comprising a flexible material having a poor adhesion characteristic to at least one bonding material.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a sectional view, taken in a plane through a central longitudinal axis, of an MR gradient coil set assembly in accordance with an embodiment.

FIG. 2 is a cross-sectional view taken along line 2-2 of the MR gradient coil set assembly of FIG. 1 in accordance with an embodiment.

FIG. 3 is a block diagram of a top view of a tool for creating a passive shim location within a gradient coil in accordance with an embodiment.

FIG. 4 is a perspective view of the tool of FIG. 3 for creating a passive shim location within a gradient coil in accordance with an embodiment.

FIG. 5 is a perspective view of a gradient coil assembly including a plurality of tools as shown in FIG. 3 in accordance with an embodiment.

FIG. 6 is a perspective view of a gradient coil assembly having a plurality of passive shim locations in accordance with an embodiment.

FIG. 7 illustrates a method of creating a passive shim location within a gradient coil in accordance with an embodiment.

### DETAILED DESCRIPTION

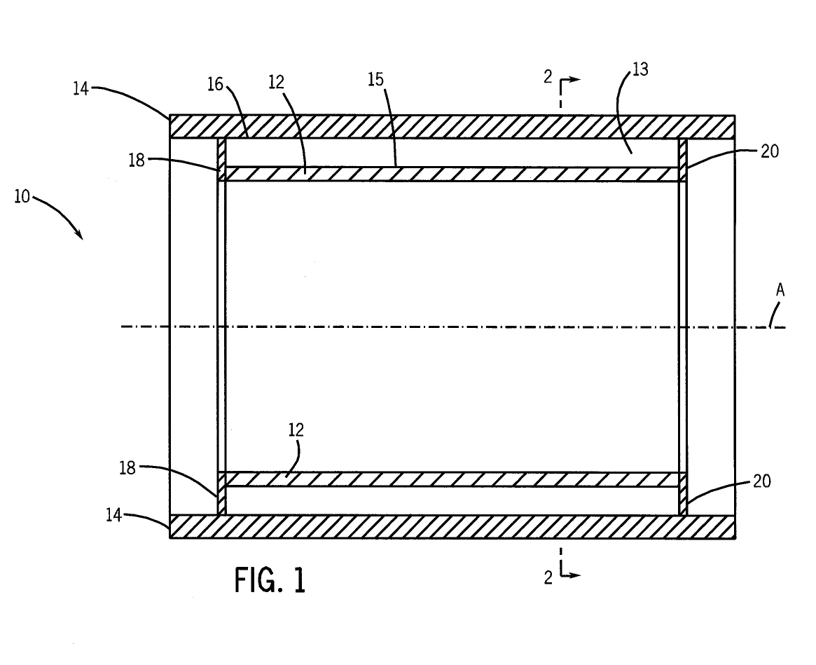

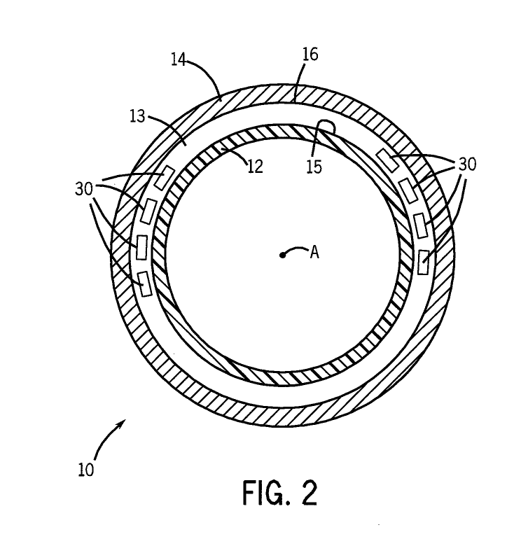

FIGS. 1 and 2 show a self-shielded gradient coil assembly 10 for an MR imaging system (not shown). FIG. 1 is a sectional view, taken in a plane through a central longitudinal axis, of a MR gradient coil assembly and FIG. 2 is a cross-sectional view taken along line 2-2 of the MR gradient coil assembly of FIG. 1. In FIGS. 1 and 2, the gradient coil assembly 10 comprises a cylindrical inner gradient coil assembly or winding 12 and a cylindrical outer gradient coil assembly or winding 14 disposed in concentric arrangement with respect to a common axis A. Inner gradient coil assembly 12 includes inner coils of X-, Y-, and Z-gradient coil pairs, or sets, and outer gradient coil assembly 14 includes the respective outer coils of the X-, Y- and Z-gradient coils pairs or sets. Gradient coil assembly 10 shown in FIGS. 1 and 2 may be inserted into the bore of a main magnet (not shown) of an MRI system so that axis A aligns with the bore axis of the main magnet (not shown). The coils of the gradient coil assembly 10 may then be activated by passing an electric current through the coils to generate a gradient field in the bore as required for MR imaging.

A volume 13 of space between inner gradient coil assembly 12 and outer gradient coil assembly 14 is filled with a bonding material, e.g., epoxy resin, visco-elastic resin, polyurethane, etc. In another embodiment, an epoxy resin with filler material such as glass beads, silica and alumina may be used as the bonding material. The epoxy joins substantially each point on an outer surface 15 of the inner gradient coil assembly 12 to an inner surface 16 of the outer gradient coil assembly 14. In various embodiments, a cooling tube (not shown) may be wound around the outer diameter surface 15 of the inner gradient coil assembly 12 and a cooling tube (not shown) may be formed on the inner diameter surface 16 of the outer gradient coil assembly 14. The cooling tubes may be held in place by the epoxy. Various elements such as cooling tubes, supports, suspension members, brackets, etc. are not shown in FIGS. 1 and 2 for clarity. In one embodiment, the epoxy used in volume 13 may contain alumina particulate material to increase its thermal conductivity. This enhances the effectiveness of the epoxy in conducting heat, generated by the respective gradient coils, away from inner and outer gradient coil assemblies 12 and 14 and to cooling tubes (not shown). In addition to providing good thermal conductivity, the epoxy layer is air cured and is provided with a mechanical strength to resist the forces generated when electric currents are coupled to the gradient coils.

FIG. 1 shows the cylindrical inner gradient coil assembly 12 and the outer gradient coil assembly 14 joined at their respective ends to end rings 18 and 20. The end rings 18 and 20 are provided to hold the inner gradient coil assembly 12 and the outer gradient coil assembly 14 in a radially spaced apart coaxial relationship. End rings 18 and 20 may be fixed to the inner gradient coil assembly 12 and the outer gradient coil assembly 14 using fastening devices (not shown) such as brackets, screws, etc. End rings 18 and 20 hold the inner and outer gradient coil assemblies 12 and 14 in the desired spaced apart coaxial relationship while the epoxy (or other bonding material) in volume 13 cures or sets up. After the epoxy has cured, the end rings 18 and 20 are typically removed.

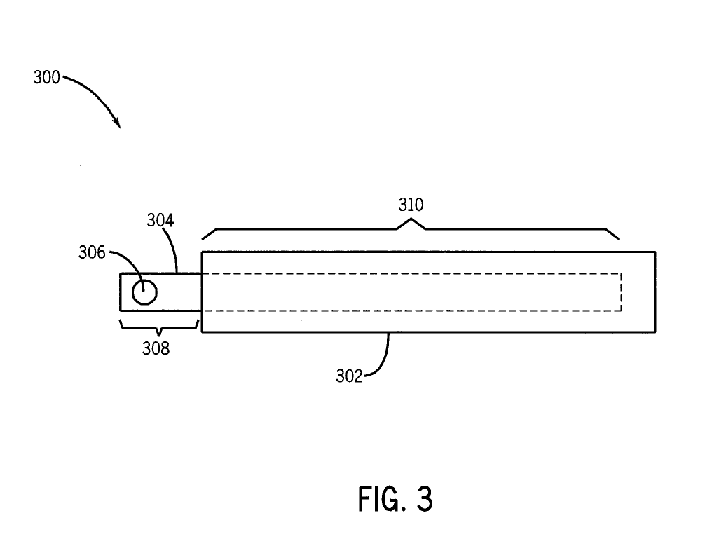

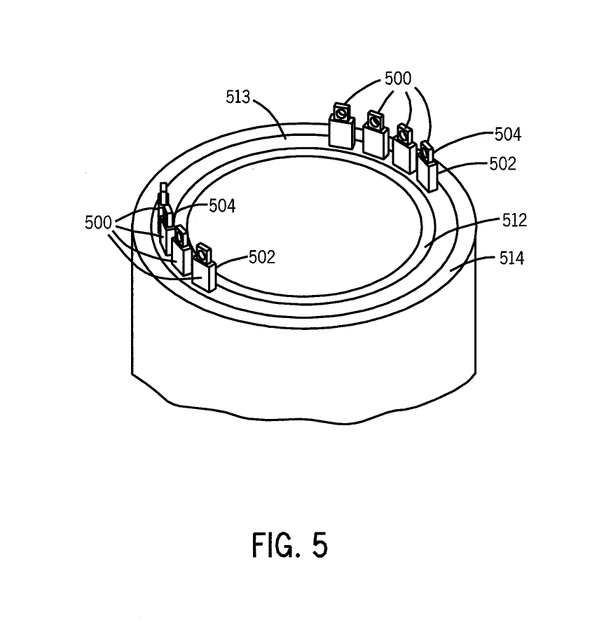

Referring to FIG. 2, the epoxy in volume 13 may also include at least one passive shim location or slot 30. In the embodiment shown in FIG. 2, multiple passive shim locations or slots 30 are formed in the epoxy layer. While eight passive shim locations or slots 30 are shown in FIG. 2, it should be understood that fewer or more passive shim slots 30 may be provided in the epoxy layer 13. The passive shim locations may be, for example, equally spaced throughout the epoxy layer. In one embodiment, thirty-six equally spaced passive shim locations may be provided in the epoxy layer. Each passive shim location 30 is created with dimensions appropriate to receive a passive shim as described further below with respect to FIG. 5-7. Each passive shim slot 30 may have the same dimensions or alternatively, one or more of the passive shim slots 30 may have different dimensions that the other passive shim slots 30. A passive shim may be, for example, a small plate made of a ferromagnetic metal, such as iron, and may be held in a removable tray. FIG. 3 is a block diagram of a top view of a tool for creating a passive shim location within a gradient coil assembly in accordance with an embodiment. Tool 300 has an inner core 304 and a flexible outer sleeve 302. Inner core 304 is removably housed within outer sleeve 302. Inner core 304 has a length greater than a length of the outer sleeve 302 so that a first portion 308 of inner core 304 is not covered by outer sleeve 302 and a second portion 310 of inner core 304 is covered by outer sleeve 302. A hole 306 may be provided on the second portion 308 of inner core 304. Hole 306 may be used as an attachment point to remove the inner core 304 from the outer sleeve 302. Alternatively, inner core 304 may be provided without a hole in the second portion 308.

The dimensions and shape of the slot 30 (shown in FIG. 2) are controlled by the dimensions and shape of outer sleeve 302 of tool 300. Preferably, outer sleeve 302 is fabricated using a molding process so multiple sleeves may be produced without costly machining. Tool 300 is shown with a rectangular profile or shape, however, it should be understood that other profiles or shapes may be used. Preferably, tool 300 has a profile without thin sections or sharp corners. In various embodiments, tools with different profiles or shapes can be used to create passive shim locations or slots with different profiles or shapes within the same gradient coil assembly. Tool 300 may be configured with dimensions so that the profile or shape of a particular passive shim slot varies along the length of the gradient coil to, for example, provide axial restraint in one direction. In one embodiment, the inner core of the tool may be provided with a slight bend (not shown) or twist (not shown) in order to create a passive shim slot with a slight bend or twist. It may be advantageous to create a slot with a slight bend or twist to ensure a tight fit of a passive shim tray within the slot and to prevent vibration of the passive shim tray. Alternatively, a slight bend or twist may be provided in the passive shim tray.

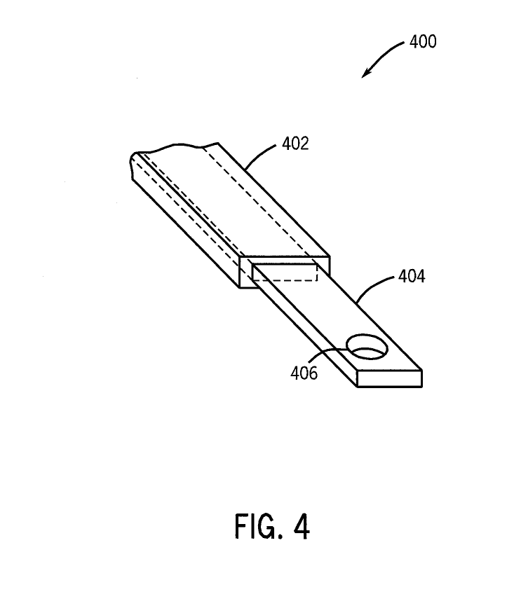

FIG. 4 is a perspective view of the tool of FIG. 3 for creating a passive shim location within a gradient coil in accordance with an embodiment. Inner core 404 is fabricated from a stiff mechanical material such as aluminum, GRP (Glass Reinforced Plastic) such as G10 or FR4, stainless steel, steel, brass, etc. Inner core 404 is removeably housed in outer sleeve 402. Outer sleeve 402 may be made from a flexible material (e.g., silicone rubber) that has poor adhesion to the bonding material, such as epoxy resin, used in the gradient coil assembly. A tool 400 made from material such as aluminum and silicone rubber will be lightweight and easy to handle. In another embodiment, outer sleeve 402 may comprise glass tape or a glass cloth. In another embodiment, outer sleeve 402 may comprise a thin walled (e.g., 1-2 mm) glass reinforced plastic sleeve. Alternatively, the glass tape, glass cloth or glass reinforced plastic sleeve (not shown) may be wrapped around the exterior of a silicone rubber (or other flexible material) outer sleeve 402. Inner core 404 is not bonded to outer sleeve 402 so that the inner core 404 may be removed from outer sleeve 402. Preferably, the material used for inner core 404 has a low friction coefficient or requires a low extraction force to be removed from outer sleeve 402. As discussed above with respect to FIG. 3, a hole 406 may be provided in the inner core 404 to be used as an attachment point to remove inner core 404 from outer sleeve 402.

As mentioned, tool 300, 400 may be used to create a passive shim location in a gradient coil, in particular, in the bonding material used to join an inner gradient coil assembly and an outer gradient coil assembly. FIG. 5 is a perspective view of a gradient coil assembly including a plurality of tools as shown in FIG. 3 in accordance with an embodiment. A tool 500 or a plurality of tools 500 are placed in a volume 513 between an inner gradient coil assembly 512 and an outer gradient coil assembly 514. The number of tools 500 used will correspond to the number of passive shim slots desired. The volume 513 is then filled with a bonding material such as epoxy resin. After the epoxy has cured or set up, each tool 500 may be removed. In particular, an inner core 504 of each tool is removed from a corresponding outer sleeve 502. Then the flexible outer sleeve 502 is removed, leaving a slot. For example, an outer sleeve 502 made of silicone rubber does not bond to the epoxy and may be removed by pulling. As mentioned above, in alternative embodiments, the inner core 504 may be wrapped in glass tape, glass cloth or a glass reinforced plastic sleeve. In these embodiments, the glass tape, glass cloth or glass reinforced plastic sleeve will become impregnated with the resin and become part of the gradient coil assembly structure. The inner core 504 would be removed and the glass tape, glass cloth or glass reinforced plastic sleeve that remains in the slot after the resin cures may prevent cracking and weakness in the resin. In another embodiment, as mentioned above, the glass tape, class cloth or glass reinforced plastic sleeve (not shown) may be wrapped around the exterior of a silicone rubber (or other flexible material) outer sleeve 502. The glass tape, glass cloth or glass reinforced plastic sleeve will become impregnated with the resin and remain in the resin after the inner core 504 and silicone rubber sleeve 502 are removed.

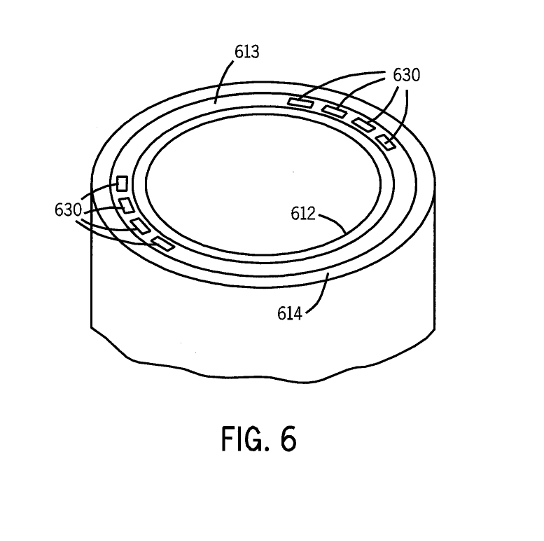

FIG. 6 is a perspective view of a gradient coil assembly having a plurality of passive shim locations in accordance with an embodiment. Once a tool 500 (shown in FIG. 5) is removed, a slot 630 remains between the inner gradient coil assembly 612 and the outer gradient coil assembly 614. As discussed above, the dimension and shape of a slot 630 is controlled by the dimensions and shape of the tool (not shown) used to create the slot 630. While eight passive shim slots 630 are shown, it should be understood that fewer or more passive shim slots 620 may be formed in the epoxy layer 613 between the inner gradient coil assembly 612 and the outer gradient coil assembly 614. For example, in one embodiment, thirty-six equally spaced passive shim locations may be provided in the epoxy layer.

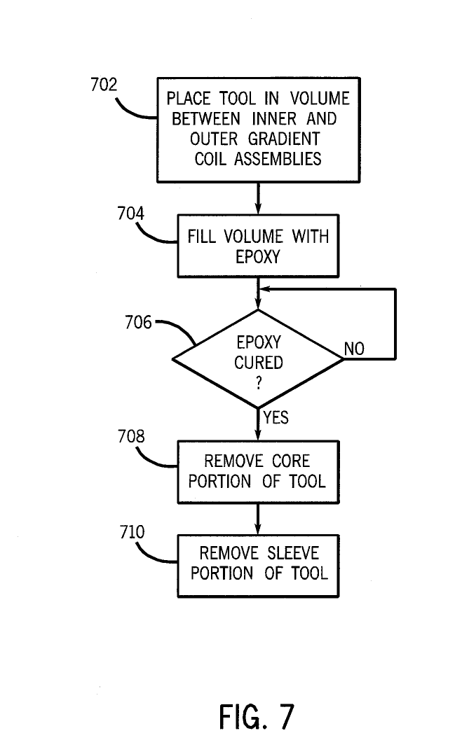

FIG. 7 illustrates a method of creating a passive shim location within a gradient coil in accordance with an embodiment. At block 702, a tool (e.g., tool 300 shown in FIG. 3) is placed in a volume between an inner gradient coil assembly and an outer gradient coil assembly. Multiple tools may be placed in the volume to create multiple locations or slots. Each tool comprises an inner core removably housed in an outer sleeve. At block 704, the volume between the inner and outer gradient coil assemblies is filled with a bonding material such as epoxy resin. At block 706, if the epoxy has not cured, the process waits until the epoxy has cured. Once the epoxy has cured, the process proceeds to block 708. At block 708, the inner core of the tool (or tools) is removed from the corresponding outer sleeve. Then, at block 710, the outer sleeve of the tool (or tools) is removed from the epoxy in the volume between the inner and outer gradient coil assemblies leaving a slot. The slot is configured to receive a passive shim. In embodiments where the outer sleeve is formed of glass tape, glass cloth or a glass reinforced plastic, the outer sleeve is not removed at block 710 since the glass tape, glass cloth or glass reinforced plastic remains in the epoxy. In an embodiment where the outer sleeve is silicone rubber and is further wrapped in a glass tape, glass cloth or glass reinforced plastic, both the inner core is removed (block 708) and the outer sleeve is removed (block 720).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. The order or sequence of any process or method steps may be varied or re-sequenced according to alternative embodiments.

Many other changes and modifications may be made to the present invention without departing from the spirit thereof. The scope of these and other changes will become apparent from the appended claims.

We claim:

1. A method for creating a passive shim location in a gradient coil assembly of a magnetic resonance imaging system, the method comprising:
placing at least one tool in a volume between an inner gradient coil assembly and an outer gradient coil assembly, the tool comprising an inner core and an outer sleeve wherein the inner core is housed in the outer sleeve;
filling the volume with a bonding material;
once the bonding material has cured, removing the inner core from the outer sleeve; and
removing the outer sleeve from the volume.

2. A method according to claim 1, wherein the passive shim location is a slot.

3. A method according to claim 1, wherein a plurality of tools are placed in the volume, the method further comprising:
once the bonding material has cured, removing the inner core from each tool in the plurality of tools; and
removing the outer sleeve of each tool in the plurality of tools.

4. A method according to claim 1, wherein the bonding material is epoxy resin.

5. A method according to claim 1, wherein the inner core is made of aluminum.

6. A method according to claim 1, wherein the outer sleeve is made of silicone rubber.

7. A method according to claim 1, wherein the outer sleeve has a set of dimensions and a set of dimensions of the passive shim location are defined by the set of dimensions for the outer sleeve.

8. A tool for creating a passive shim location in a gradient coil for a magnetic resonance imaging system, the tool comprising:
an inner core; and
an outer sleeve configured to removably house the inner core, the outer sleeve comprising a flexible material having a poor adhesion characteristic to at least one bonding material.

9. A tool according to claim 8, wherein the inner core is made of aluminum.

10. A tool according to claim 8, wherein the flexible material is silicone rubber.

11. A tool according to claim 8, wherein the at least one bonding material is epoxy resin.

12. A tool according to claim 8, wherein the outer sleeve has a set of dimensions and a set of dimensions of the passive shim location are defined by the set of dimensions for the outer sleeve.

13. A tool according to claim 8, further comprising a layer of glass-based material disposed around the outer sleeve.

14. A tool according to claim 13, wherein the glass-based material is one of glass tape, glass cloth or glass reinforced plastic.
